(19) United States
(12) Patent Application Publication
(10) Pub. No.: US 2018/0013758 A1
(43) Pub. Date: Jan. 11, 2018

(54) METHOD AND SYSTEM FOR DYNAMIC PASSWORD BASED USER AUTHENTICATION AND PASSWORD MANAGEMENT

(71) Applicant: Hai Yu, Woodbury, MN (US)

(72) Inventor: Hai Yu, Woodbury, MN (US)

(21) Appl. No.: 15/206,315

(22) Filed: Jul. 11, 2016

(51) Int. Cl. H04L 29/06

(52) U.S. Cl. CPC H04L 63/0846; H04L 63/06; H04L 63/10

(57) ABSTRACT

The method and system for providing user authentication and password management using user specified dynamic password. A dynamic password is generated based on user defined implicit password construction rules that are only known to the user. This method allows the password used for user authentication to be different at each time of use through information references and formulated operations. The method and system further comprise separated password authentication application and password protected storage device to create a highly secured password management system. After pairing the authentication application to the password protected storage device, the authentication application first inquires the storage device for dynamic password definition. It next generates an internal instance of the dynamic password by processing the prescribed references and operations. It then compares the user input password with the internal dynamic password instance, and, based on the comparison result, accepting or rejecting the user identity claim.

### TECHNICAL FIELD

The present invention relates to a dynamic password-based user authentication method. The invention further relates to a password management and user authentication system comprising such dynamic password authentication method.

### BACKGROUND

As internet based connected information systems penetrate to every corners of our life, authentication method to manage proper information usage and information system access become more and more critical to our network based life security. User names and passwords are used by network information systems and applications as the primary user authentication method. A typical network information system user has passwords to control access to protected information on computer systems, mobile devices, user accounts, ATMs, etc. On the other hand, loss of password becomes annoyance to users, and password cracking has become a major concern of unauthorized information abuse.

There are many new security technologies appeared in recent years to provide alternative methods for user authentication. Security tokens such as physical keys or smart cards offer an alternative or complement to passwords. Biometric user authentication is based on sampling of user's physiological or behavioral characteristics. Perceptual passwords are based on the observation that humans find it easier to recall complex patterns when expressed as pictures. However, due to lack of portability and robustness as well as their high costs, their applications have been largely limited in only specific areas. Passwords are straightforward to use and can be efficiently entered using e.g. conventional computer keyboards or numeric keypads, which enable them to still be the dominant form of authentication method in web security applications and access control systems.

Unfortunately, research in information security indicates that passwords are not well adapted to the way human process information. In general, users find passwords difficult to remember and a solution many users adopt is to reduce the complexity and number of passwords across applications, which reduces the security obtained through the passwords. This situation becomes increasingly worsen as we are setting up user accounts and passwords on more and more web based connected information applications. Remembering all the user accounts and passwords becomes impossible for common people. On the other hand, using simple passwords and reusing them in multiple applications makes us vulnerable to malicious information hackers.

A solution to this issue is to use a password manager. Password managers store user's login information for all the websites and applications, and they help logging into them automatically. They encrypt user password database with a master password—the master password is the only one a user have to remember. Unfortunately, while using one master password to manage the access to the rest of user passwords, the security of the master password is still questionable. A static password can still be subjective to stealth over time, and is vulnerable to so-called shoulder surfing security attacks. To address this problem, frequent password change is still required, which make it again inconvenient for user to remember. There is thus a need for method and system to improve both the convenience and the security of conventional password-based user authentication and password management systems.

The invented dynamic password authentication method and management system is able to provide an optimized solution by achieving both elevated information security and human friendly access convenience. In this method, user password is generated dynamically such that the explicit password changes at each time of use while the implicit kernel, a set of rules, to generate such dynamic password is easy to remember and is only known to the user. Furthermore, for password management based on the dynamic password method, the user authentication information storage is physically separated from the authentication service application to provide further mobility convenience and robust protections. A password management system protected by the invented dynamic password is thus highly secured and is invulnerable to cracking attacks. Furthermore, the same dynamic password can also be used to access multiple systems since its explicit form varies from time to time and is thus different when accessing different systems.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a method, a system, and a computer readable medium encoded with instructions for authenticating user access to protected information storage system using dynamic password generation and validation methods.

In a preferred embodiment of this invention, a user requests to access a protected information storage system via a user access Authentication Application System (AAS). The information storage system is protected by a dynamic password based information access control process. A dynamic password is a password that comprises dynamic elements to change its explicit instance at each time of use while the implicit rules to generate such dynamic password is predefined and is only known to the user. As a result, a user can always tell the present expression of the dynamic password based on his/her knowledge about the dynamic password generation kernel. The user figures out the present expression of the dynamic password in mind and input it to AAS in order to have authorized access to information saved on the Dynamic Password Protected System (DPPS).

After the AAS initiates, it first sends communication connection request to the DPPS. Once received, the communication device on the DPPS will pair to the communication device on the AAS to build up data communication channel. After that, the reference rule defined for each of the dynamic elements in DPPS's protecting dynamic password will be transmitted to AAS. The AAS is able to process the reference rules and obtain reference data either from memory location and computer programs on AAS, or from hypertext data at destination web locations on an extended information network. The collected reference data for all the dynamic elements are then transmitted back to DPPS. Based on the received reference data and the defined operation rules, DPPS is able to determine the instance expression for each of the dynamic elements. The DPPS further determines the expression for static elements and non-effective elements if any of them are defined in the dynamic password. After that, the final instance of the dynamic password is synthesized based on the expressions of all the password elements and their designated positions in the password structure.

A user who defines the dynamic password is able to find out the reference data by visiting the referenced data source. The user further performs the dynamic password operation rule and expression method in mind to work out the content and instance expression of the dynamic password at the time of use. After receiving user input password via user interface device, AAS transmits the user input password to DPPS for validation. A comparison between the user input password and the synthesized dynamic password instance is carried out on DPPS. The user's access requests to the information stored on DPPS will then be authenticated given that the comparison result is validated. Otherwise, the access requests will be denied.

In some other embodiment of this invention, the dynamic password instantiation process and the dynamic password validation process are both executed in AAS. The DPPS in these realizations of the invented user access authentication system works only as a passive storage device to store dynamic password definition and encrypted information data. The dynamic password instantiation procedures that used to be done on DPPS are all finished on AAS. The dynamic password definition may further contain cryptographic key that is provided to AAS after a successful dynamic password validation such that the encrypted information on DPPS can be transformed from cipher text into plain text or into understandable information format.

In some embodiments of the present invention, a dynamic password is defined as an array of password elements. A user who defines the dynamic password specifies the number of elements and structure of the dynamic password array. A password element is a unit processing component to generate the final instance expression of the dynamic password. Each of the password elements has a designated position in the dynamic password array and an expression method defined for it to determine its final presentation in the dynamic password instance expression. The position of a password element can either be absolutely defined or it can be specified relatively with respect to the position of other password element.

The expression method defined for a password element can take many different formats using computer based coding methods for objects. A simple embodiment of password element is in Unicode characters. Other embodiment of password element comprises other characters, like Chinese characters. Some other embodiments of password element can be in the format of figure, audio record, video record, object description, motion description, mathematic and logic expressions, etc. It can be in the format of a single object or a sequence of objects.

The first type of password element is non-effective element that does not impact the comparison result in the password validation process if only its expression satisfies its own expression method definition. A non-effective element has its expression method defined to guide user in finding an explicit presentation for it. The second type of password element is effective element that comprises static element and dynamic element. Effective elements have expression method and comparison method defined for each of them. All effective elements will be evaluated in the password validation process by comparing its internal instance expression generated by application to its counterpart expression from user input. The comparison assessment determines the password validation result and the final user access authentication state.

A static element has fix content and expression that do not change after a dynamic password definition is finished. A dynamic element is unique in the dynamic password based authentication method and system. A dynamic element has reference rule and operation rule further defined for it such that its instance changes according to the variation of its referred information source data. At the time of usage, for each of the dynamic elements defined in a dynamic password, the reference rule will be executed first to get the reference data from its specified destination information source. The reference data are further processed based on the prescribed operation rule to generate the content for each of the dynamic elements. After that, the instance for each of the dynamic elements is achieved by converting its content to its final expression using the expression method defined for each of them. Next, the expressions of dynamic elements are filled in to the dynamic password at their designated positions in the dynamic password array. The final instance of the dynamic password is completed with the decided expressions of the static elements and the non-effective elements if any of them are defined. The instance of the dynamic password can then be used for user authentication application where a user input password is compared to it in order to validate user's credential claim. In some embodiments of the present invention, multi-dimension dynamic password array is used, for example, a 2-dimension array.

The reference rule defined for a dynamic element defines the relationship that links the content of the dynamic element to data at an information source. In some embodiments of the reference rule, the referred information source is either a memory location on a local or remotely connected computerized device that stores a computer program processing result, data record, etc. In some other embodiments of the reference rule, the referred information source is a hyperlinked information data on the extended information network. Some other exemplary embodiments of the reference rule further comprise: a dependence rule on the instance of other dynamic element; a reference to a predefined character set, etc.

The operation rule defined for a dynamic element provides an algorithm or a computer program that is used to derive the content of the dynamic element from the reference data. The operation rule specifies the mathematic and logic relationships between the content of the dynamic element and the reference data.

A user's request to access protected information on DPPS is authenticated by validating the comparison result between the user input password and the explicit instance of the dynamic password synthesized at the time of user access request. The comparison assessment is achieved using the comparison method defined for each of the effective elements. In a fundamental embodiment of the validation process, a deterministic comparison method is used, where the instance expression of an effective element needs to be exact the same as the expression of its counterpart section in the user input password. In some embodiments of the validation process, a fuzzy comparison method is used, where the match may be less than 100% perfect and the instance expression of an effective element approximates the expression of its counterpart section in the user input password. In some other embodiments of the validation process, a pattern based comparison method is used, where the abstract expression pattern of an effective element is compared to the expression pattern of its counterpart in the user input password, where the format used for pattern expression is not important. In some other embodiments of the validation process, an inclusive matching method is used, where the comparison result is generated by checking if the instance expression of an effective element contains the expression of its counterpart section in the user input password or if it is contained in it.

In some other embodiments of the validation process, a candidate matching comparison method is used, where the comparison result is generated by matching the user input expression of an effective element to at least one instance expression prescribed in a set of candidate expressions define for the effective element. The candidate matching comparison is very useful when defining a mode determining dynamic element. A mode determining dynamic element has multiple candidate instances at the time of usage. When the expression of the user input element matches one of the candidate instances of the dynamic element, the comparison result is validated towards authorizing user access request. Each of the candidate instances has mode associated to it. By matching different instances of the mode determining dynamic element, the user's access, after authenticated, will be directed to different modes of information usage. Exemplary authenticated modes of information usage include but not limited to privilege mode, displaying mode, user type and authorization mode, etc. This method provides additional control on information access through multi-access password management.

Some other validation processes may incorporate more than one comparison methods. A dynamic password comparison assessment result can be generated after the instantiation of the whole dynamic password. Alternatively, element-wise comparison result can be first evaluated for each of the effective elements. After that, the final dynamic password comparison assessment can be synthesized from the element-wise comparison results.

In some embodiments of the invention, a compound dynamic password is used. A compound dynamic password comprises multiple dynamic password sections where each of them is defined by a different user. Alternative, a dynamic password section in a compound dynamic password can be an embedded third-party auto-generated passcode whose generation mechanism is unknown to the user.

In some embodiments of this invention, a dynamic password validation process comprises the following execution steps. First, the definition of a dynamic password is loaded. Second, the reference and operation rules defined for each of the dynamic elements are processed to determine the final instance expression for each of the dynamic elements. Next, the expressions of all the static effective elements are decided. Optionally, the expressions of non-effective elements are finalized. After receiving user input password, user access authentication is granted by validating the comparison result between the user input password and the instance of the dynamic password.

In some embodiments of the user access authentication system, the AAS comprises a user interface to communicate and display information to the user and also to take user inputs. The AAS comprises communication devices to establish data communication with DPPS and with an extended information network. Exemplary embodiments of the extended information network are internet and intranet, which the AAS connects through computer and communication networks. The AAS further comprises application system memory and at least one processor to execute instructions to provide user access authentication application, information data communication applications and user interface applications, etc.

In some embodiments of the user access authentication system, the DPPS comprises at least one communication device to provide data communication between AAS and DPPS. The DPPS comprises a protected system memory to store dynamic password definition data, dynamic password protected data and a program of instructions supporting user authentication system applications. The DPPS further comprises at least one processor to provide computer program operations including: dynamic password generation, user password comparison and validation, data communication with AAS, user access control and secured information management, etc.

Illustrative embodiments of the present invention are directed to method and system for dynamic password based user access authentication. Additional features and advantages of the invention will be made apparent from the following detailed description of illustrative embodiments.

### BRIEF DESCRIPTION OF THE DRAWINGS

FIG. 1 is a schematic diagram of a user authentication method using dynamic password that comprises a dynamic password definition process and a dynamic password validation process according to one or more embodiments;

FIG. 2 is a schematic diagram of an exemplary one-dimension dynamic password according to one or more embodiments;

FIG. 3 is a schematic diagram of an exemplary 2-dimension dynamic password according to one or more embodiments;

FIG. 4 is a flowchart illustrating a method for dynamic password definition process according to one or more embodiments;

FIG. 5 is a flowchart illustrating a method for dynamic password validation process according to one or more embodiments;

FIG. 6 is a flowchart illustrating a method for comparing user input password to dynamic password according to one or more embodiments.

FIG. 7 is a schematic diagram of a user authentication system that provides service to authenticate user access from an authentication application system to a dynamic password protected information system according to one or more embodiments;

FIG. 8 is a flowchart illustrating a method for authentication service process on the authentication application system according to one or more embodiments;

FIG. 9 is a flowchart illustrating a method for authenticating user access to dynamic password protected information system according to one or more embodiments;

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses methods and systems for authenticating user access to protected information storage system using dynamic password generation and validation methods. When information data saved on a Dynamic Password Protected System (DPPS) is needed, a user will request to access DPPS via a user access Authentication Application System (AAS). Information data saved on DPPS are secured and encrypted. Access to DPPS is authenticated through a dynamic password based information access control process. A dynamic password is a password that comprises dynamic elements to change its explicit instance at each time of use while the implicit kernel, a set of predefined rules, to generate such dynamic password is only known to the user. The user who defines the dynamic password is able to find out the reference information data and to apply the dynamic password generation rules in mind to figure out the instance of the dynamic password at the time of use. The user will input the dynamic password to AAS via user interface device. AAS then transmits the received user input password to DPPS for validation. DPPS carries out a comparison assessment between the user input password and the computer processed dynamic password instance. The user's access requests to information stored on DPPS will then be authenticated given that the comparison assessment result is validated. Otherwise, the access requests will be denied.

By keeping the dynamic password generation kernel private to the user, the explicit instance of the dynamic password is only used once and its explicit expression can be different at each time of usage. Such a dynamic password based user access authentication method is not only highly secured, but also convenient. The user only needs to remember its kernel definition rather than its instance expression. The same dynamic password can be repetitively used to access multiple dynamic password protected information systems. Furthermore, by physically separating the dynamic password protected information storage system from the authentication application system, a dynamic password based user access authentication system keeps the information data invulnerable from cracking and hacking attempts while it is still able to provide flexible and convenient access control services. A user-friendly and highly secured password management system is thus realized.

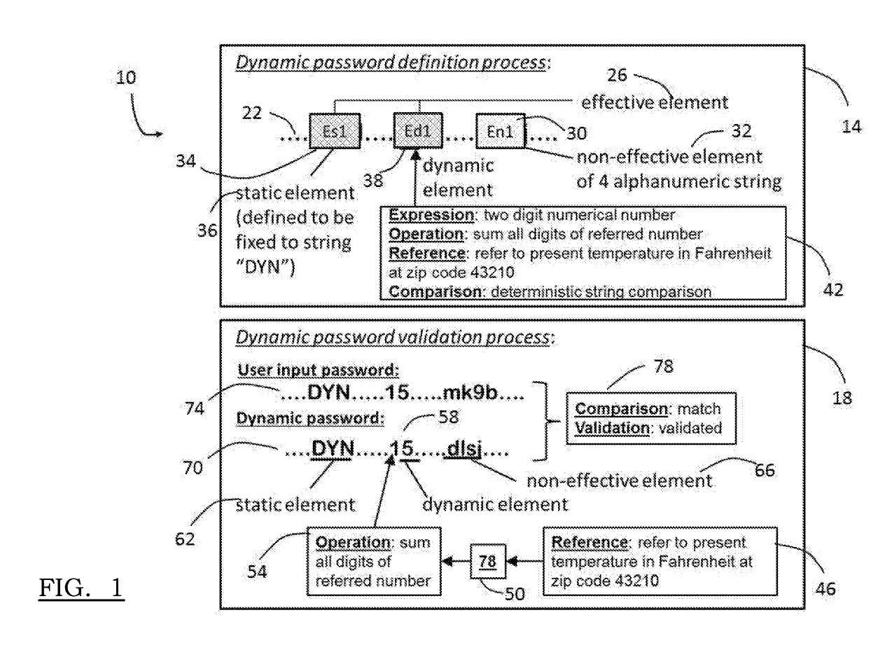

With reference to FIG. 1, a schematic diagram of a user authentication method using dynamic password is illustrated in accordance with one or more embodiments and is generally referenced by numeral 10. This method comprises a dynamic password definition process 14 and a dynamic password validation process 18. In a primary embodiment of the invention, a dynamic password array 22 is constructed with a sequence of password elements that are illustrated either by element blocks 26 and 30 or by dots. The dots used in dynamic password array 22 and the expressions 70 and 74 represent password elements that will not be discussed in this exemplary illustration of the user authentication method 10. The description can thus focus on demonstrations of the dynamic password definition and validation processes using element examples 30, 34 and 38.

A dynamic password definition process starts with decision on the password structure and number of password elements. They can be decided before the dynamic password element specifications. Alternative, they can be automatically determined after a user adds new element to the dynamic password and arranges the new element to a specific position in the dynamic password array. A typical dynamic password array is a one-dimensional array. In some embodiment of the invention, multi-dimension dynamic password array, like 2-dimension array, is used to provide additional structural security.

An element of dynamic password is a unit processing component to generate the final expression of the dynamic password. Every password element has its designated position in the dynamic password array and its expression method. The position of a password element can be a sequential position in a one-dimensional array or it can be a vector position in a multi-dimensional array. The position of a password element can either be defined absolutely in the dynamic password structure or it can be defined relatively with reference to the position of other password element. The expression method defined for a password element can take many different formats using computer based coding methods or mathematic model for different objects. A simple embodiment of password element is in the format of Unicode characters. Other embodiment of password element comprises other characters, like Chinese characters. Some other embodiments of password element can be in the format of objects like figure, audio record, video record, object description, behavioral motion description, mathematic and logic expressions, etc. The expression of a dynamic element password can either take the format of a single object or it can be constructed by a sequence of objects.

The first type of password element is non-effective element 30 that does not impact the comparison result in the password validation process if only it is correctly presented. An exemplary non-effective element 30 is illustrated in the dynamic password definition process 14 by an element block labeled “En1”. The expression method guides the presentation of a non-effective element and it help to recognize its section of expression in the user input password. Even though the content of a non-effective element can be arbitrarily selected and it does not impact the password comparison and validation result, its expression at corresponding user input section still needs to comply with its format definition. Otherwise, the user input password is regarded as invalid. Due to its arbitrary nature, non-effective elements add difficulty to password cracking attempts. In this example, expression method 32 defines a string consisting of 4 alphanumeric characters. In some other examples, the length of the non-effective element string can also be flexible and not fixed. This is useful especially when the non-effective element is at the end of a dynamic password array. Other than alphanumeric string, the expression of a non-effective element can also take many other expression formats but the definition has to make it recognizable as a unit password expression.

The second type of password element is effective element 26 that comprises static element 34 and dynamic element 38. Effective elements have additional comparison method defined for each of them. All effective elements will be evaluated in the password validation process to generate comparison assessment that determines the password validation result and the final user access authentication state. To support the comparison assessment, the expression method for effective element is important and it has to be strictly defined for each of the effective elements.

A static element has constant content and expression that do not change after the dynamic password definition process is finished. A conventional alphanumeric password can be regarded as a dynamic password consisting of only one static element. As illustrated in FIG. 1, the static element 34 at the position of element block “Es1” has fixed content and expression of a three-character alphanumeric string “DYN”. For its comparison method, a deterministic rule can be used to verify whether the user input password has exact string “DYN” at the element position corresponding to that of the static element “Es1” 34.

A dynamic element is unique in the dynamic password based authentication method and system. Besides its position, expression method and comparison method definitions, a dynamic element has reference rule and operation rule defined for it such that its instance varies corresponding to the latest value of its reference data. The reference rule defined for dynamic element states the relationship that links the content of the dynamic element to data at an information source. In some embodiments of the invention, the information source is either a parameter value at a local or remote memory location, a computer program processing result, or a hyperlinked information data on an extended information network, like a data from URL or data on a webpage. Some other exemplary embodiments of reference rule further comprise: a dependence rule that refers to the instance of other dynamic element; a mode determination rule that refers to candidates in a predefined instance expression set; etc. The operation rule defined for dynamic element provides algorithm or computer program to derive the content of dynamic element from the reference data. The operation rule specifies the mathematic and logic relationships between the content of the dynamic element and the reference data.

The definition 42 specified for the exemplary dynamic element “Ed1” 38 comprises an expression method, a comparison method, an operation rule and a reference rule. In this example, the reference rule setup data linkage to a hyperlink data on http://openweathermap.org through an API call api.openweathermap.org/data/2.5/weather?zip=43210,us. This reference rule states that the content of this dynamic element refers to the present temperature in Fahrenheit at zip code 43210. The operation rule states that the content of this dynamic element is the sum of all digits of the reference data. The expression method prescribes that the end expression of this exemplary dynamic element is in the format of 2 digit number. The comparison method chosen is a deterministic comparison method such that the two digit number at corresponding section of the user input password has to be exactly the same as the number at the position of dynamic element 38.

At the time of usage, for each of the dynamic elements, the reference rule is first executed to retrieve the reference data from destination information sources. For dynamic element “Ed1” 38, the reference data 50 is determined by executing the reference rule 46 using an API command to obtain the present temperature in Fahrenheit at zip code 43210. As a result, reference data value 78, corresponding to 78 degree Fahrenheit, is obtained from openweathermap.org. Next, the reference data are processed based on the prescribed operation rule to derive the content for dynamic element 38. The operation rule 54 is applied to sum up all the digits of reference data 50 to get the result “15” from the calculation “7+8=15”. At last, the content of the dynamic element has to be converted to its designed format according to its expression rule. In this example, the expression conversion is easy as number “15” is already a 2-digit numerical number. The instance expression of dynamic element 38 is then filled in to the dynamic password 70 at its designated position 58.

To complete the instance expression of the dynamic password 70, the expression of the static element 34 is obtained from its definition as the 3-character string “DYN” 62 and it is filled in at the element position according to its position definition. The expression for the non-effective element 30 can optionally be determined by randomly selecting alphanumeric characters to construct the 4-character string “dlsj” 66. The dynamic password 22 achieves an instance expression 70 as “...DYN....15....dlsj....” in the dynamic password validation process 18.

The user input password 74 has a string of characters “...DYN....15....mk9b....”. It is compared to the instance of the dynamic password 70 to evaluate its correctness. When the same expression method and comparison method are defined for all the effective elements, the password validation comparison can be carried out over the expression of the whole dynamic password 70 at once. Otherwise, the password validation comparison has to be first performed element-wisely and then evaluated to get the final comparison assessment result 78 for the whole dynamic password. In this illustrative example, element-wise evaluation is used to demonstrate the comparison and validation process. By applying element-wise comparison using deterministic comparison method, both the static element 34 and the dynamic element 38 have the same expressions with their counterparts in the user input password. The resulted comparison assessment regards them as the same with a score “match” such that the validation state is set to “validated”.

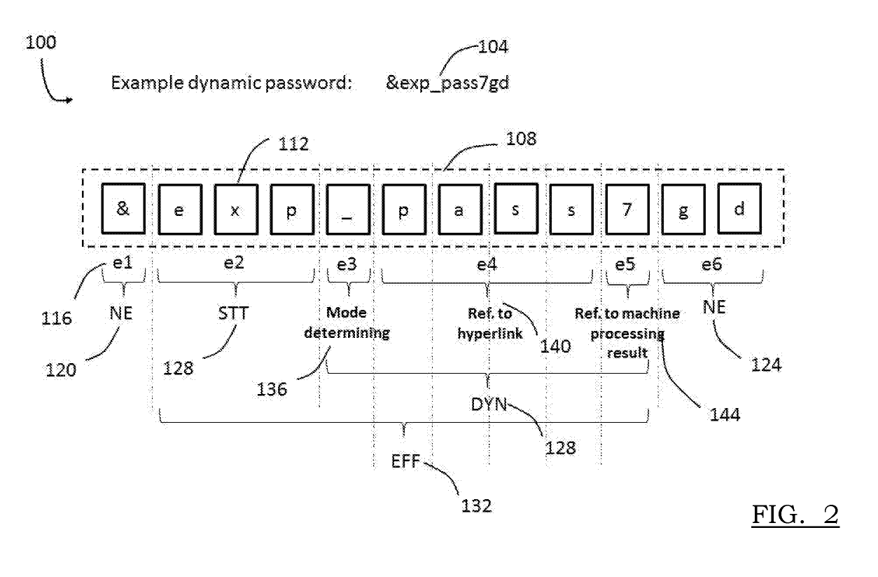

With reference to FIG. 2, a schematic diagram of an exemplary one-dimension dynamic password is illustrated according to one or more embodiments and is generally referenced by numeral 100. This is a simple exemplary one-dimension dynamic password whose expression contains only alphanumeric characters. An instance expression of this exemplary dynamic password is “&exp_pass7gd” 104. To better illustrate the components of this dynamic password example, this instance expression is first decomposed into a sequence of alphanumeric characters 108 with each character is shown in a block 112. In this example, all the characters are belong to 6 password elements with labels 116 as “e1”, “e2”, to “e6”.

The password element “e1” is a non-effective element “NE” 120 assigned at the first position in the password array. It has an expression method defined as a one alphanumeric character. Thus, the instance of “e1” can be any alphanumeric character and it takes the symbol “&” in this example. A non-effective element can be used and arranged at anywhere in the password array. They are used to add complexity to the password expression and their randomness makes it difficult for password theft and cracking attempts. In this example, there is another non-effective element “e6” 124 at the end of the dynamic password array. It is defined as a 2 character alphanumeric element. A non-effective element can have non-fixed length to add difficulty to shoulder surfing attacks.

In this example, the second password element “e2” 128 is defined as a static element labeled as “STT”. This static element has fixed content and expression as “exp”. The third password element “e3” 136 is a mode-determining dynamic element. The fourth element “e4” 140 is a dynamic element that has its reference rule pointing to a hyperlinked data. The fifth element “e5” 144 is a dynamic element that has its reference rule point to a computer program based machine processing result. The elements “e3”, “e4” and “e5” constructs the dynamic element section 128 that is labeled as “DYN”. The element “e2” and the “DYN” section 128 together construct the effective element section 132 and this section is labeled as “EFF”. The effective elements do not need to stay next to each other in a dynamic password array. They can be arranged anywhere in this array and they can be spaced with non-effective elements in between.

A dynamic element has its content generated from a referred data or mathematically modeled object at an information source. The information source can be a memory location, a computer program's parameter value, a candidate value from a parameter set or a data from hyperlink network address/parameter. The dynamic element “e4” is an example that has its reference rule specified to link to a network address data through hyperlink. Such a reference rule can retrieve data either embedded in URLs that contains parameter names and values from a website or inside a message that contains parameter names and values received from an application server. Such parameter value is updated on the website or on the application server regularly based on computer processing result, event, measurement, phenomena, or time period. In application, AAS will read the website's URL or send API command to obtain the latest updated parameter value. On the user side, the user also knows where to find the reference data. This can be as simple as to explore a website, to read present time and date, to view an application window displayed on screen, etc. The use is thus able to resolve the content of a dynamic element at the time of access request. This is done in parallel to the computer operation based instantiation process for the same dynamic element on AAS and DPPS.

The dynamic element “e5” is an example that has its reference rule specified to obtain data from a computer program processing result. Exemplary computer programs include but not limited to random number generator, game, application gadget, communication data, etc. computer program processing result can also be a computer program parameter or data file that stores the result from real events, like a football game, a census, lottery, election, etc. In application, AAS visits a destination memory location to obtain the computer program processing result. On the user side, such computer program processing result is usually displayed to the user via AAS's user interface device.

The dynamic element “e3” is an example of the mode determining dynamic element that has its reference rule defined with respect to a set of prescribed candidate element expressions. A mode determining dynamic element has multiple valid candidate instances at the time of usage. When the expression of the user input element matches one of the candidate instances of the dynamic element, the comparison result is validated towards authorizing user access request. Each of the candidate instances has mode associated to it. By matching different instances of the mode determining dynamic element, the user's access, after authenticated, will be directed to different mode of information usage. Exemplary modes of information usage include but not limited to privilege mode, displaying mode, user type and authorization mode, etc. This method provides additional control on information access through multi-access password management.

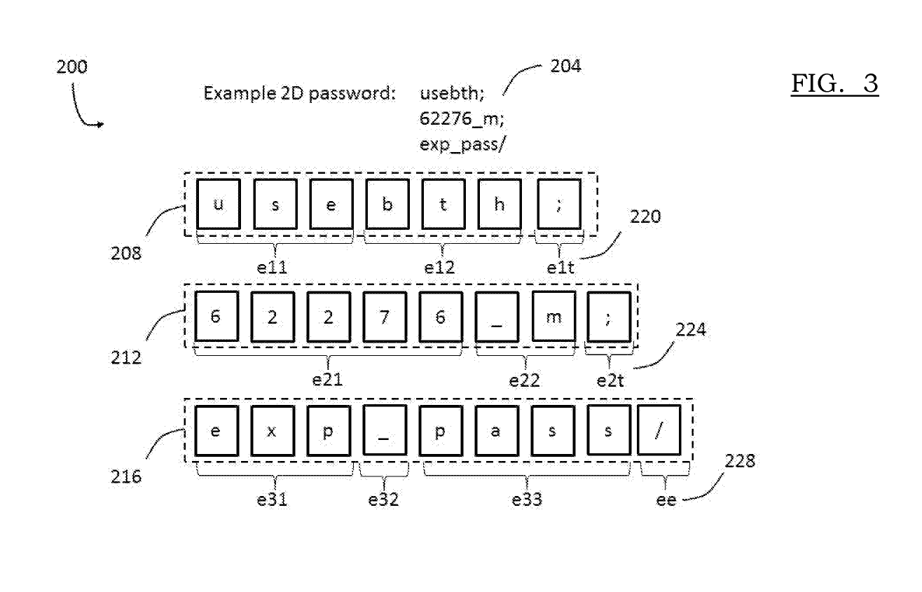

With reference to FIG. 3, a schematic diagram of an exemplary 2-dimension dynamic password is illustrated according to one or more embodiments and is generally referenced by numeral 200. This 2-dimension dynamic password example 200 has an instance expression 204 as: “usebth; 62276_m; exp pass/”, which contains three rows of expressions 208, 212, 216. Each row of the 2-dimention dynamic password can contain variable numbers of password elements with a special end-of-row element defined to separate the rows. For example, after the two password element e11 and e12, the first row 208 has an end-of-row element elt 220 that is defined to use character “;”. The end-of-row elements for different rows can be same or different. In this example, the second row 212 uses the same character “;” for its end-of-row element e2t 224. The 2-dimension dynamic password has a terminal element defined to indicate the end of the whole password expression. In this example, the third row 216 has terminal element ee 228 defined with expression “/” to tell that this is the last row of the 2-dimension password. In application, the end-of-row element corresponds to the “enter” key input in user input password and the terminal element corresponds to the “confirm” key input in the user input password.

In some embodiments of the multi-dimension dynamic password, the end-of-row element and the terminal element may not be the last element in a row but before the last row element. In some other embodiments of the multi-dimension dynamic password, a special structural indication element is used to tell how many password elements are defined for the present row. A special character is usually used to indicate this definition and it can be arranged anywhere in a row to communicate the structural information defined to the application programs on the AAS or on the DPPS. For example, “#5” can be used, where “#” indicates that this is a structural indication element and “5” tells that there are 5 password elements in the present row. Such structural indication element does not expect to have a counterpart expression in the user input password. It only serves to tell the host computer how to generate an instance of the multi-dimension dynamic password. A regular single-dimension dynamic password array does not need any of such structural elements in its definition.

In some embodiments of the invention, a compound dynamic password is used. A compound dynamic password comprises multiple dynamic password sections where each of them is defined by a different user. In some other embodiments of the invention, a dynamic password section in a compound dynamic password can be an embedded third-party auto-generated password whose generation mechanism is unknown to the user.

The dynamic elements used in the dynamic password based user authentication method and system can be of many types. The most fundamental type of dynamic element is alphanumeric character string. The expression method and reference data format are usually all in alphanumeric character string and normally the deterministic comparison method is used that requires the instance expression of the dynamic element string matches its counterpart expression in the user input password exactly. The operation rule defined for an alphanumeric string type of dynamic element can be chosen from a large variety of mathematic and logic operations. For example, a dynamic element has its reference data link to an alphabetic string at a position in a hypertext webpage. The present string is “news”. The operation rule states that the content of the dynamic element converts each letter in the reference data string to the letter after it in the alphabet. The content of the dynamic element is thus “ofxt”. For another example, a dynamic element has its reference data link to the present ETZ hour in a two digit format. At the time of user request, the ETZ time is 13:26. The reference data is thus 13 in this example. The operation rule set for it states that, given the reference data X, the content of the dynamic element Y is derived as: Y=(X/2−mod(X/2))̂2. This equation states that the content of the dynamic element Y equals to the square of the integer part of quotient from X divided by 2. At time of application, when user reads the present time is 13:26 or 1:26 pm, he/she divides 13 by 2 and get the integer value 6. The final content is thus 36, which will be filled in to the user input password according to its expression definition. For the fundamental alphanumeric dynamic element, many mathematic and logic equations, as well as lookup tables, can be used as the operation algorithm.

A dynamic element can also be a string of characters contains non-ASCII encoded characters like Chinese characters. On the user side, the user can input such character string using handwriting tools on the AAS user interface. The received user input characters are recognized and encoded according to their corresponding character coding standard for communication and element expression. A deterministic comparison method for this type of dynamic element can be character code comparison for each of the special characters in the dynamic element expression.

A dynamic element can further be of any object format based on a figure, a video/audio record, a pattern expression, etc. For example, a dynamic element refers to a picture object. The operation rule defined applies an algorithm that evaluates how red the picture is, that is, to compute the percentage of pixels that have color value within a certain range. The expression rule categorizes the percentage into verbal codes based on the numeric value of the percentage. Such verbal codes can be: all red, mostly red, half red, lightly red, and not red. On the user side, the user watches the same picture to get his/her perceptive judgment on the redness of this picture and input the final evaluation verbal code to AAS. A fuzzy comparison method is usually used in this validation assessment is made based on how close the user judgment is to the computer evaluation result, but not on their exact match.

A dynamic element can have expression method defined with different instance expression and user input expression. For example, a dynamic element refers to the name of a song that is presently playing at radio channel FM405.8. The operation rule for this dynamic element is an equivalent operation such that the content of the dynamic element is the name of the song. On the other hand, the user input expression of this dynamic element can either be a typed string or an audio record. The audio record, if used, can either be the name of the song read by the user, or it can be the lyric singing by the user. The comparison method in this case comprises multiple conditional statements on the comparison validation. If input string is received, the user input name of the song is compared to the instance name of the song for an approximate matching assessment. If the received user input is an audio record of user speaking, it is first processed to extract the content of the audio record using voice recognition tools and then to compare the content to the instance name of the song in an approximate matching manner. If the received user input is an audio record of singing, the audio record is compared to subsections of the song to find containing match between the user singing voice record and the audio record of the song. The dynamic element can thus be validated given that the user input expression does have strong correlation to the expression derived from the reference data.

A dynamic element can be pattern based that has its reference data pointing to an object that contain certain pattern expression. For example, a dynamic element refers to present trading price variations from 5 predetermined stocks arranged in a sequence. If a stock is increasing in price, it is regarded as “+”, or as “−” vice versa. At any time, the variations of the 5 stocks give a pattern of “+” and “−” sequence. For instance, “++−−+” is obtained as the content of this dynamic element. On the user side, the user observes the price variation of the selected 5 stocks and input the pattern of them as “ppmmp”, or “aabba”, or “good good bad bad good”, or “ball ball strike strike ball” or any other format of input expression if only it contains a pattern expression. The comparison method used for this type of dynamic element is pattern matching that first extracts the pattern content from the user input expression irrespective of its original format, and then compares the extracted pattern to the instance pattern expression.

A mode determining dynamic element has multiple candidate instance expressions. If only the user input expression for this dynamic element matches one of the candidate instance expression, the dynamic element is verified and validated. Usually, a mode determining dynamic element is defined such that each of the candidate instances has mode associated to it. By matching different candidate instance expressions of it, the user's access, after authenticated, will be directed to different mode of information usage. Exemplary modes of information usage include but not limited to privilege mode, displaying mode, user type and authorization mode, etc. This method provides additional control on information access through multi-access password management. For example, a user setup dynamic password to his/her bank account. The dynamic password contains a mode determining dynamic element with a set of candidate expressions as: {$, %, &}. When the user input expression for this dynamic element matches “$”, owner access right is granted to the user and the user can access this bank account with all operation functions. When the user input expression for this dynamic element matches “%”, viewer access right is granted and the instant user is provided with only account information without doing any operation on it. When the user input expression matches “&”, fake access right is granted, where the account balance displayed is 16 dollars rather than the true balance of 465800 dollars.

In another example of the mode determining dynamic element application, a user setup dynamic password to access vehicle for his family members. The candidate instance expressions for a dynamic element are from set: {_parent_, _grandparent_, _teenager_}. A user input password contains any of the candidate instance expressions from this set can be authenticated to use this vehicle. While an input expression as “_parent_” can use the full functions of this vehicle, an input expression as “_grandparent_” will automatically set the vehicle to COMFORT mode with all assisted functions activated. When the input express is “_teenager_”, the vehicle control system switches to SUPERVIDED mode such that the vehicle speed cannot exceed 80 mph. More comprehensive mode determining dynamic element can also be defined such that the element candidates have reference rule and operation rule to generate their final instance expressions.

In an exemplary embodiment of dynamic password application, a user setup dynamic password for Wi-Fi based home network. The Wi-Fi access dynamic password comprises a dynamic element expressed in two digit number that refers to the present date. For example, on January 10^{th}, the explicit expression of the Wi-Fi password is “mywifipass10_owner”, where the number “10” is the instance expression of the dynamic element. By enabling the Wi-Fi password to change regularly, the possibility of hacking to this Wi-Fi network can be significantly reduced. Furthermore, when mode determining dynamic element is defined at the end of the Wi-Fi password, user authentication can be based on the expression of the password used. The candidate instance expressions for the mode determining dynamic element are from set: {_owner, _visitor, _controlled}. While the owner uses password “mywifipass10_owner” to access the Wi-Fi network on January 10^{th}, the password “mywifipass10_visotor” can be given to family visitors with limited network speed. And the password “mywifipass10_controlled” can be given to kids such that additional parental control can be added to network usage.

A dynamic element can also be a gadget or application applying other types of password technologies. For example, a dynamic element can use security token or RSA code as its content. A dynamic element can also use biometric authentication based on sampling of user's physiological or behavioral characteristics. Unique identifiers include fingerprints, hand geometry, earlobe geometry, retina and iris patterns, voice waves, DNA, and signatures. Other types of dynamic element also apply perceptual or graphical password technologies.

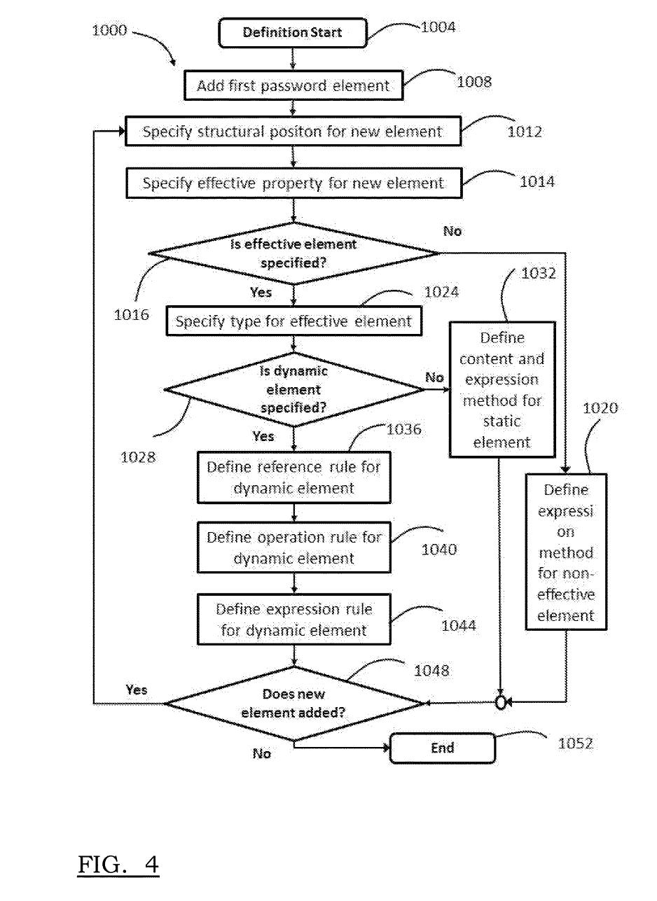

With reference to FIG. 4, a method for dynamic password definition process is illustrated according to one or more embodiments and is generally referenced by numeral 1000. After starting at step 1004, the first new password element is added to the definition at step 1008 and its structural position is determined in the password array at step 1012. These two steps can be a drag-and-arrange process using a webpage based dynamic password definition application. Next, the property of the password element is specified at step 1014. When seeing a non-effective element is defined at step 1016, the method 1000 switches to step 1020 where the expression method is defined for the non-effective element. Even though the content of a non-effective element does not affect the dynamic password validation process, its expression method shall still be specified to guide how the non-effective element shall be. This definition is useful for user to finalize the final input expression of a dynamic password when constructing it in mind. After step 1020, the method 1000 goes next to step 1048 to check if the dynamic password definition process is finished or not. When seeing an effective element is specified at step 1016, the method 1000 switches to step 1024 to specify the type of the new effective element. If a new static element is defined at step 1024, the method 1000 switches to step 1032 to further define the content and expression method for the new static element, and goes to step 1048 once done. On the other hand, if a dynamic element is defined at step 1024, the method 1000 next goes to step 1036 to define the reference rule for the new dynamic element. And subsequently at step 1040 and step 1044, the operation rule and expression rule are given to the new dynamic element. After that, the method 1000 checks if there is other new element added to the dynamic password definition at step 1048. When user adds additional new element, the method 100 goes back to step 1012 to repeat the structural and property specification process for the new element. Otherwise, the method 100 ends at step 1052.

In the dynamic password definition method 1000, the structure of the dynamic password, the position of the elements and the dimension of the password array, is clearly defined and finalized after all the password element are added and arranged to a designated positon. During the process, missing structural elements can be automatically filled in to the dynamic password array, or be suggested to the user, in order to complete a correct password definition. In an alternative embodiment of the dynamic password definition method 1000, the structure of the dynamic password array can be outlined first before specifying element properties and rules. This structural arrangement step determines the number of element for a single-dimension dynamic password array, and it determines the number of rows and number of element for each row if a two-dimension dynamic password array is to be defined.

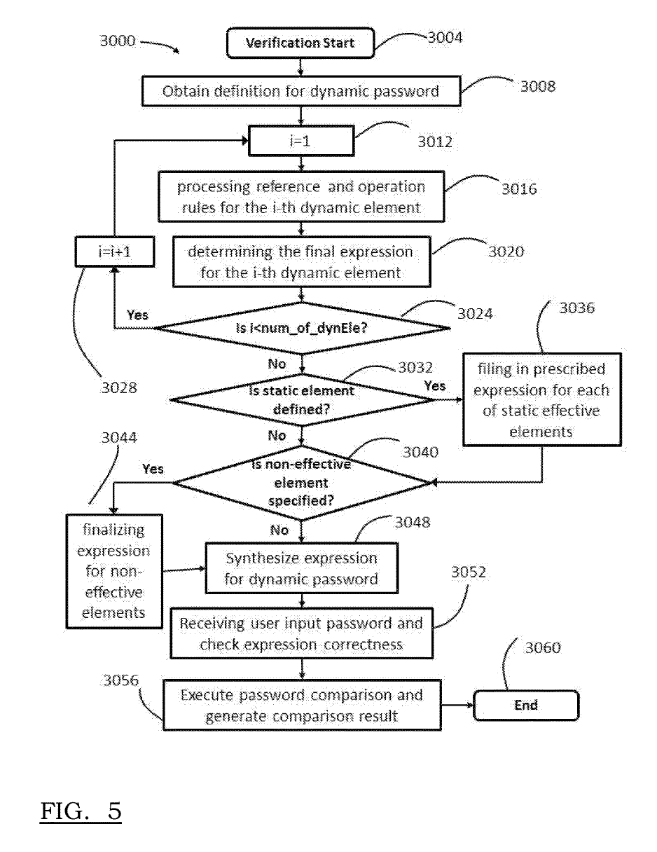

With reference to FIG. 5, a method for dynamic password validation process is illustrated according to one or more embodiments and is generally referenced by numeral 3000. A typical dynamic password validation process comprises the following execution steps. First, the definition of a dynamic password is loaded. Second, the reference and operation rules defined for each of the dynamic elements are processed to determine the final instance expression for each of the dynamic elements. Next, the expressions of all the static effective elements are decided. Optionally, the expressions of non-effective elements are finalized. After receiving user input password, user access authentication is granted by validating the comparison result between the user input password and the instance of the dynamic password. After starting the validation process at step 3004, the dynamic password definition is loaded to the application system at step 3008. The dynamic element index is set to i=1 at step 3012. The reference rule and the operation rule are executed at step 3016 to retrieve the present reference data and to resolve the content for the i-th dynamic element. Next at step 3020, the final instance expression for the i-th dynamic element is determined based on its resolved content and expression method definition. The method 3000 continues to determine the final instance expression for all the dynamic elements until the index variable i reaches the total number of dynamic elements, num_of_dynEle, at step 3024. Otherwise, the index i increases by one at step 3028 and repeats the dynamic element instantiation steps 3016 and 3020. After done with all the dynamic elements, the method 3000 next checks if there is static element defined for this dynamic password at step 3032. If so, defined content and expression for each of the static elements is used to fulfill the instance expression of the dynamic password at step 3036. After this step, or when there is no static element defined, the method 3000 checks if non-effective element is defined for this dynamic password at step 3040. Optionally, non-effective elements, if defined, will have their expression finalized at step 3044. The final instance expression of the dynamic password is next synthesized by combining all the expressions of password element based on their structural positon definition at step 3048. After receiving the user input password at step 3052, the correctness of the user input password is first checked by partitioning the elements and verifying that the expression of each of the elements satisfies the expression method definition defined for this element. When this check fails, the user input password is regarded as invalided and the user may be reminded to input the password again. When this check succeeds, the password comparison method for each of the elements are carried out to verify the compliance of the user input password to the instantiation of the dynamic password at step 3056. Based on the comparison result generated at step 3056, authentication decision can then be made with respect to a user's information access request. After that, the method ends at step 3060.

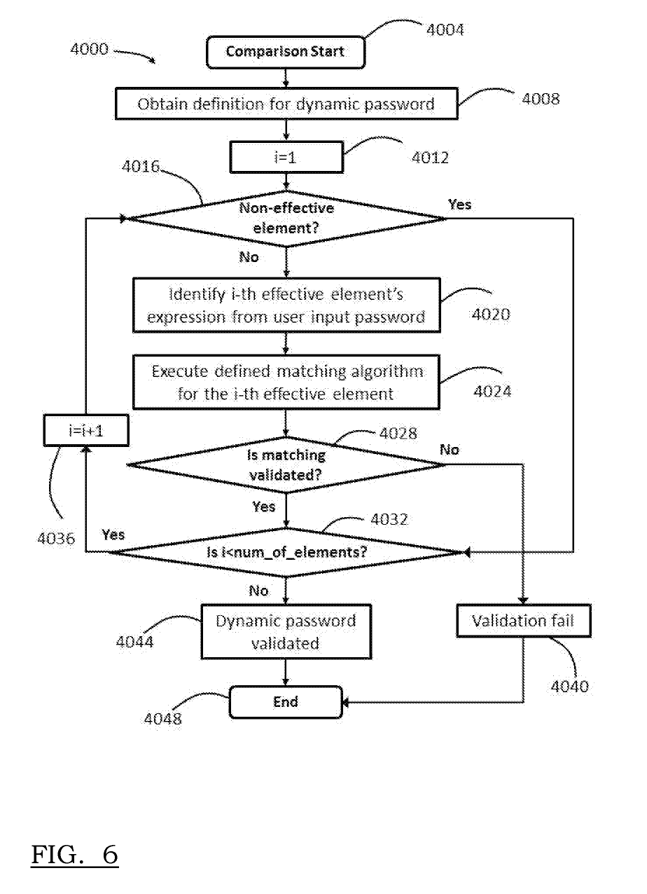

With reference to FIG. 6, a method for comparing user input password to dynamic password is illustrated according to one or more embodiments and is generally referenced by numeral 4000. After starting at step 4004, the comparison method 4000 first load the dynamic password definition at step 4008. The password element index is set to one, i=1, at step 4012. Then, for the i-th element, it first checks on whether it is a non-effective element at step 4016. Non-effective elements are ignored in the comparison process and the method 4000 continues to work on the next password element at step 4032. If the i-th element is an effective element, its input expression is extracted from the user input password at step 4020. In the meantime, its instance expression is loaded from the result of the element instantiation process. And the element matching algorithm is loaded according to the i-th element's comparison method definition. After that, the element matching algorithm is executed to assess the match between the input expression and the instance expression of the i-th element at step 4024. Given that the comparison result is satisfactory, the method 4000 continues to work on the next element at step 4032 until the element index reaches the total number of element, num_of_elements. Otherwise, the element index increases by one at step 4036 and goes back to step 4016. In the presence of any failed element matching comparison, the process aborts at step 4040 and the validation fails. The dynamic password validation process is successfully achieved after all the effective elements are verified with matching input expression to their counterpart's instance expression at step 4044. The process ends at step 4048.

A user's request to access protected information on DPPS is authenticated by validating the comparison result between the user input password and the explicit instance of the dynamic password that is generated at the time of user access authentication request. The comparison and validation process can be achieved using many different methods. In a fundamental embodiment of the process, a deterministic comparison method is used, where the instance expression of an effective element needs to be exact the same as the expression of its counterpart section in the user input password. In some embodiments of the process, a fuzzy comparison method is used, where the match may be less than 100% perfect and the instance expression of an effective element approximates the expression of its counterpart section in the user input password. In some other embodiments of the process, a pattern based comparison method is used, where the abstract expression pattern of an effective element is compared to the expression pattern of its counterpart in the user input password, where the objects used for expression are not important but how they are organized. In some other embodiments of the process, an inclusive matching method is used, where the comparison result is generated by checking if the instance expression of an effective element contains the expression of its counterpart section in the user input password or if it is contained in it.

In some other embodiments of the process, a candidate matching comparison method is used, where the comparison result is generated by matching the user input expression of a dynamic element to at least one instance expressions prescribed in a set of candidate expressions. The candidate matching comparison is very useful when defining a mode determining dynamic element. Some other embodiments of the process incorporate more than one comparison methods to construct a comprehensive comparison process.

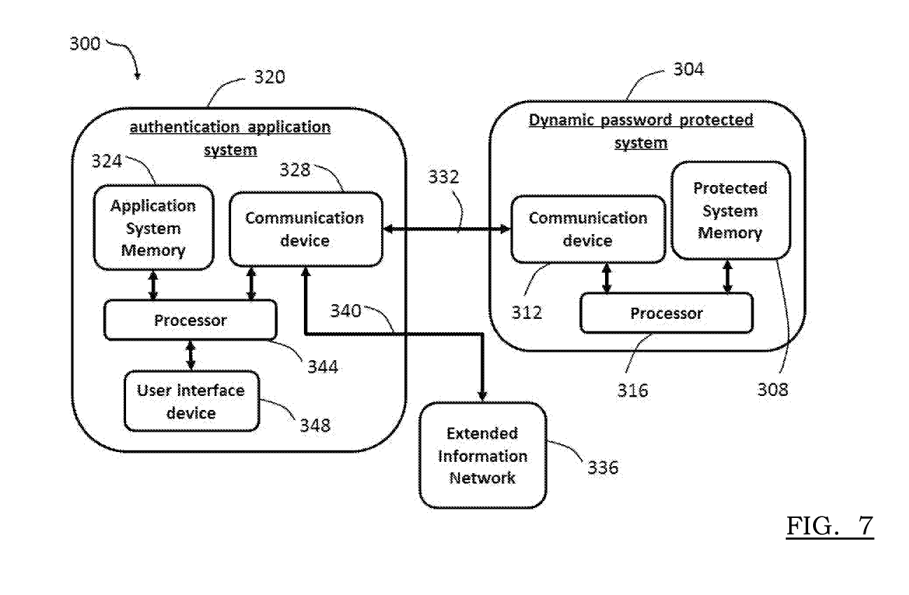

With reference to FIG. 7, a user authentication system that provides service to authenticate user access is illustrated in accordance with one or more embodiments and is generally referenced by numeral 300. The service system 300 comprises AAS 320 and DPPS 304. The AAS 320 comprises a user interface 348 to communicate and display information to the user as well as to take user inputs. The AAS 320 comprises communication device 328 to establish data communication 332 with DPPS 304 and data communications 340 with an extended information network 336. Exemplary embodiments of the communication devices include internal computer communication between instruction executions, wired communication connection like Ethernet cable and USB, wireless communication like Wi-Fi and Bluetooth and RFID, but not limited to them. Exemplary embodiments of the extended information network 336 are internet and intranet, which the AAS 320 connects through computer and communication networks. The AAS 320 comprises application system memory 324 and at least one processor 344 to execute instructions to provide applications comprising: user access authentication; information data communication; user interface; information access management; password and user credential management; etc.

The DPPS 304 comprises at least one communication device 312 to provide data communication 332 with AAS 320. Exemplary embodiments of the communication devices include internal computer communication between instruction executions, wired communication connection like Ethernet cable and USB, wireless communication like Wi-Fi and Bluetooth and RFID, but not limited to them. The DPPS 304 comprises a protected system memory 308 to store dynamic password definition data, dynamic password protected information data and application program instructions. The DPPS 304 comprises at least one processor 316 to execute computer program instructions supporting applications comprising: dynamic password generation, user password comparison and validation, data communication with AAS, user access control and secured information management, etc.

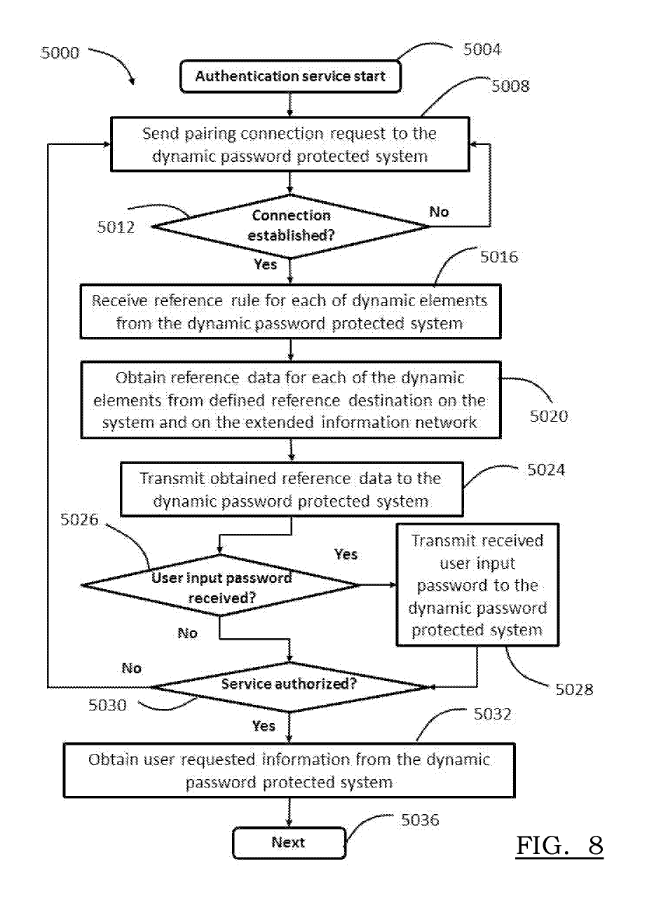

With reference to FIG. 8, a method for authentication service process on the AAS is illustrated according to one or more embodiments and is generally referenced by numeral 5000. After the AAS initiates at step 5004, it first sends pairing connection request to the DPPS at 5008 until successful data communication is established between AAS and DPPS at step 5012. After that, the AAS receives the reference rule for all the dynamic elements defined in the protecting dynamic password of DPPS at step 5016. The AAS is able to process the reference rules at step 5020 and obtain reference information data either from memory location and computer programs on AAS and DPPS, or from destination locations on the extended information network that AAS connects to. The collected reference data for all the dynamic elements are then transmitted back to DPPS at step 5024. A user who defines the dynamic password is able to apply the same dynamic password generation rules and find out the reference information data at the time of use. The user then figures out the instance of the dynamic password in mind and input his/her version of the dynamic password to AAS via the user interface device. AAS checks if user input password is received at step 5026. If received, AAS transmits the received user input password to DPPS for validation at step 5028. When the user access is successfully authenticated at step 5030. The AAS next loads user requested information from the DPPS to provide information service to the user at step 5032 and the method 5000 continues with other service procedures at step 5036. If the authentication fails at step 5028, the AAS can either repeats the process by going back to step 5008 or it can terminate the service.

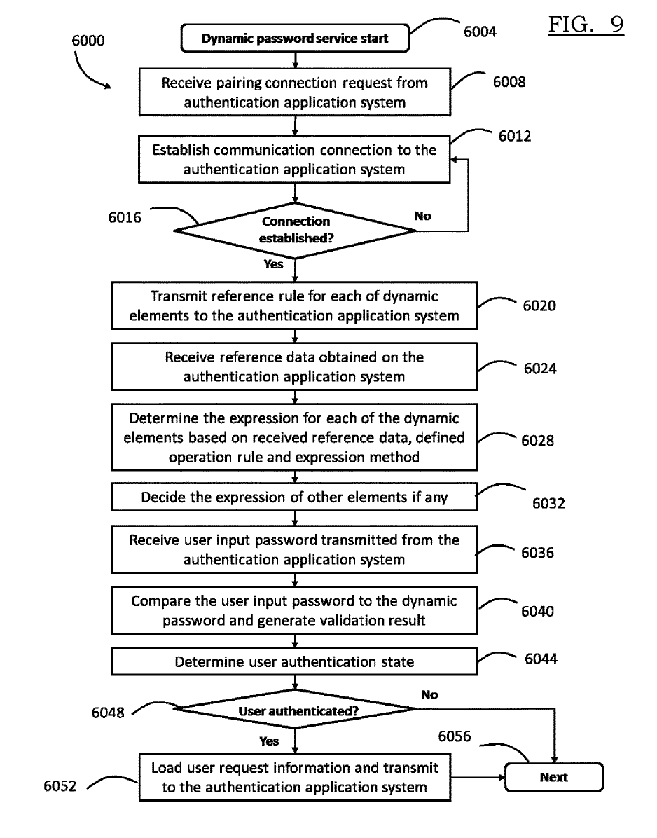

With reference to FIG. 9, a method for authenticating user access to DPPS is illustrated according to one or more embodiments and is generally referenced by numeral 6000. After the DPPS initiates at step 6004, it listens to the pairing connection request from AAS at step 6008. Once received, the DPPS starts to build up data communication channel with AAS at step 6012 until successfully establishing data communication at step 6016. After that, DPPS passes over the reference rules defined for all the dynamic elements in the protecting dynamic password to AAS at step 6020. And then it starts waiting for the reference data to echo from AAS. After receiving all the reference data collected by AAS at step 6024, DPPS is able to determine the content for each of the dynamic elements based on the received reference data and the defined operation rules at step 6028. Furthermore, the instance expressions of all the dynamic elements are resolved by applying their expression methods defined. The DPPS further determines the instance expression for the static elements and the non-effective elements if any of them are defined in the dynamic password at step 6032. After that, the final instance of the dynamic password is synthesized based on the expressions of all the password elements and their designated positions in the password structure. After receiving user input password transmitted from AAS at step 6036, a password validation process is applied at step 6040 by evaluating the correlation between the user input password and the synthesized dynamic password through element comparison at step 6040. The user's access requests to the information stored on DPPS is then authenticated given that the comparison result is validated at step 6044. Otherwise, the access requests will be denied. An authenticated user access continues to the step 6052 to load user requested information and to transmit information data to AAS. The method 6000 continues with other service procedures at step 6056.

In a first exemplary embodiment, the user access authentication system is a password management system that comprises a smartphone and a USB stick computer. The DPPS is now the USB stick computer that stores the dynamic password definition and protected user credential information. The user credential information include the username and associated passwords to different websites, computer program applications, as well as passcode to building entrance, ATM accounts, debit cards, etc. The AAS is the smartphone and an application that works together with programs on DPPS to provide user authentication and password management. After the user input password is validated and the user access to the USB stick computer is authenticated, the application on the smartphone can load information needed from the USB stick computer. For example, when the user opens a website's login page that requests username and password information, the application on the smartphone can automatically find the user name and password data associated to that website and fill in the credential data to corresponding fields. The smartphone device used in this password management system can also be laptop or other computerized devices.

Similar to the first exemplary embodiment, an alternative embodiment of the password management system comprises a smartphone and a USB memory stick. The difference is that the USB memory stick is a passive storage device that can only save password definition data, information encryption key and encrypted information data. The AAS and the DPPS application part are all on the smartphone device except the DPPS information storage is on the USB memory stick. The communications between AAS and DPPS are inside the smartphone while the function of DPPS is split to between the smartphone and the USB memory stick. The dynamic password definition saved on the USB memory stick may further contain cryptographic key that is provided after the user access to the USB memory stick information storage is authenticated such that the encrypted information on the USB memory stick can be transformed from cipher text into plain text or into other useful information formats.

Another embodiment of the user access authentication system is a transaction authorization system that comprises a transaction service control center, a transaction service terminal device and a dynamic password network server. In this application, the transaction service control center is the AAS with the transaction service terminal device as the user interface. The DPPS is now the dynamic password network server. For an illustrative example, the transaction service control center is a bank's account management and transaction control system (AMTCS). The transaction service terminal device is a card scanner that can take user's card information and user inputs. The DPPS is now on an internet based network application server (NAS) that stores user defined password definition. The user input account password is received by the card scanner and transmitted to the bank's AMTCS. The bank AMTCS further passes the user input password to dynamic password NAS for validation. After receiving the authentication result from the dynamic password NAS, the bank AMTCS will approve the transaction request from the user to finish the purchase order. Otherwise, the transaction request will be rejected. Taking advantage of the invented dynamic password authentication system, a user's band account password or band card pin can be different at each time of use. A user's credit card can have changing CVV number for online transactions. All these protection methods largely improve the transaction securities in daily life.

As demonstrated by the embodiments described above, the methods and systems of the present invention provide advantages over the prior art by generating user password dynamically such that the explicit password changes at each time of use while the implicit kernel to generate such dynamic password is stable and is only known to the user. Furthermore, for password management based on the dynamic password method, the user authentication information storage is physically separated from the authentication service application to provide further mobility convenience and robust protections. A password management system protected by the invented dynamic password is thus highly secured and is invulnerable to cracking attacks.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A method for providing user authentication using dynamic password comprises a dynamic password definition process and a dynamic password validation process, wherein said dynamic password definition process further comprising:
specifying number of password element and structure for a dynamic password array;
specifying effective elements and their positions in said dynamic password array, and defining expression method and comparison method for each of said effective elements;
specifying dynamic elements among said effective elements, and defining reference rule and operation rule for each of said dynamic elements;
And wherein said dynamic password validation process further comprising:
obtaining definition of said dynamic password;
processing said reference rule and operation rule for each of said dynamic elements, and determining the instance expression for each of said dynamic elements;
obtaining defined expression for each of static elements if any;
receiving user input password and verifying correctness of said user input password;
determining user authentication state by validating said user input password through comparison assessment with the instance expression of said dynamic password.

2. The method of claim 1, wherein said effective element further comprises static element that has fixed content and expression; and wherein said password element further comprise non-effective element whose content and expression do not impact said comparison assessment between said user input password and said instance expression of said dynamic password.

3. The method of claim 1, wherein said expression method defines the way of instance presentation for each of said effective elements using formats of objects including character, figure, audio record, video record, pattern expression, object description, motion description, mathematic and logic expressions; and wherein said expression method can further be in the format of a sequence of objects.

4. The method of claim 1, wherein said reference rule for said dynamic element defines the dynamic relationship that relates the content of said dynamic element to information data at an information source; and wherein said information source is selected from a set of information sources comprising: a memory location; a hyperlink; a message; a machine processing result; a dependence on other dynamic element; a predefined set of candidates.

5. The method of claim 1, wherein said operation rule for said dynamic element defines the algorithm that can be executed by a computer program to derive the content of said dynamic element from the reference data.

6. The method of claim 1, wherein said comparison assessment between said user input password and said instance expression of said dynamic password comprises element-wise comparison for each of said effective elements applying defined comparison method; and wherein said defined comparison method is selected from a set of comparison methods comprising:
deterministic matching method;
fuzzy matching method;
pattern matching method;
inclusive matching method;
candidate matching method.

7. The method of claim 1, wherein said dynamic element is a mode determining element that dictates the authenticated mode of information usage by matching element expression in user input password to at least one instance expression of said dynamic element among a set of candidate instance expressions, and wherein said mode of information usage controls the scope of authorized information and allowable methods of using said authorized information.

8. The method of claim 1, wherein said structure of said dynamic password array can be a multi-dimension array; and wherein said dynamic password can further be a compound dynamic password comprising multiple dynamic password sections.

9. A method for providing service to authenticate user access to a dynamic password protected system through an authentication application system comprising:
establishing data communication between said authentication application system and said dynamic password protected system;
transmitting reference rules for all the dynamic elements defined in a dynamic password from said dynamic password protected system to said authentication application system;
obtaining reference data for each of said dynamic elements on said authentication application system, and transmitting said reference data from said authentication application system to said dynamic password protected system;
determining the instance expression for each of said dynamic elements based on received reference data and the operation rule defined for each of said dynamic elements;
finalizing the instance expression of said dynamic password by deciding the expression of other elements defined in said dynamic password based on the definition for each of said other elements;
receiving user input password and transmitting said user input password from said authentication application system to said dynamic password protected system;
authenticating user access to said dynamic password protected system by validating the comparison assessment between said user input password and said instance expression of said dynamic password.

10. The method of claim 9, wherein said dynamic password is constructed by password elements with defined expression method; and wherein said password elements comprise said dynamic element that has reference rule and operation rule defined to change the instance expression of said dynamic element with respect to the variation of referred source information data.

11. The method of claim 9, wherein said other elements comprises static element that has fixed content and expression after definition; and wherein said other elements further comprises non-effective element whose content and expression do not impact said comparison assessment between said user input password and said instance expression of said dynamic password.

12. The method of claim 9, wherein said reference rule for said dynamic element defines the dynamic relationship that relates the content of said dynamic element to information data at an information source; and wherein said operation rule for said dynamic element defines the algorithm that can be executed by a computer program to derive the content of said dynamic element from said reference data.

13. The method of claim 9, wherein said comparison assessment between said user input password and said instance expression of said dynamic password comprises element-wise comparison for each of said dynamic elements applying defined comparison method; and wherein said defined comparison method is selected from a set of comparison methods comprising:
deterministic matching method;
fuzzy matching method;
pattern matching method;
inclusive matching method;
candidate matching method.

14. The method of claim 9, wherein said dynamic element is a mode determining element that dictates the authenticated mode of information usage by matching element expression in user input password to at least one instance expression of said dynamic element among a set of candidate instance expressions, and wherein said mode of information usage controls the scope of authorized information on said dynamic password protected system and allowable methods of using said authorized information.

15. A system for providing service to authenticate user access comprises a dynamic password protected system and an authentication application system, wherein said dynamic password protected system further comprising:
protected system memory, configure to store dynamic password definition data, dynamic password protected information data and a program of authentication instructions;
communication device to establish data communication with said authentication application system;
at least one processor operably coupled to said protected system memory and said communication device, configured to execute said program of authentication instructions, wherein when said program of authentication instruction is executed, carries out the steps of:
receiving connection request from said authentication application system and building up data communication connection to said authentication application system;
transmitting reference rules for all the dynamic elements in said dynamic password definition data defined for a dynamic password to said authentication application system;
receiving reference data for each of said dynamic elements from said authentication application system;
determining the instance expression for each of said dynamic elements based on received reference data and operation rule defined for each of said dynamic elements;
finalizing the instance expression of said dynamic password by deciding the expression of other elements defined in said dynamic password based on the definition for each of said other elements;
receiving user input password from said authentication application system;
authenticating user access to said dynamic password protected information data by validating the comparison assessment between said user input password and said instance expression of said dynamic password;
And wherein said authentication application system further comprising:
application system memory, configure to store a program of application instructions;
communication device to establish data communication with said dynamic password protected system, and to an extended information network;
user interface device to display information to user and to receive inputs from user;
at least one processor operably coupled to said application system memory, said communication device and said user interface device, configured to execute said program of application instructions, wherein when said program of application instruction is executed, carries out the steps of:
sending connection request to said dynamic password protected system;
receiving reference rules for all said dynamic elements defined in said dynamic password from said dynamic password protected system;
obtaining reference data for each of said dynamic elements and transmitting said reference data to said dynamic password protected system;
receiving user input password from said user interface device and transmitting said user input password to said dynamic password protected system;
obtaining user requested information from said dynamic password protected information data on said dynamic password protected system for authenticated user.

16. The system of claim 15, wherein said dynamic password is constructed by password elements with defined expression method; and wherein said password elements comprise said dynamic element that has reference rule and operation rule defined to change the instance expression of said dynamic element with respect to the variation of referred source information data.

17. The system of claim 15, wherein said other elements comprises static element that has fixed content and expression after definition; and wherein said other elements further comprises non-effective element whose content and expression do not impact said comparison assessment between said user input password and said instance expression of said dynamic password.

18. The system of claim 15, wherein said reference rule for said dynamic element defines the dynamic relationship that relates the content of said dynamic element to information data at an information source; and wherein said operation rule for said dynamic element defines the algorithm that can be executed by said program of authentication instructions to derive the content of said dynamic element from said reference data.

19. The system of claim 15, wherein said comparison assessment between said user input password and said instance expression of said dynamic password comprises element-wise comparison for each of said dynamic elements applying defined comparison method; and wherein said defined comparison method is selected from a set of comparison methods comprising:
deterministic matching method;
fuzzy matching method;
pattern matching method;
inclusive matching method;
candidate matching method.

20. The system of claim 15, wherein said dynamic element is a mode determining element that dictates the authenticated mode of information usage by matching element expression in user input password to at least one instance expression of said dynamic element among a set of candidate instance expressions, and wherein said mode of information usage controls the authorized scope of said dynamic password protected information data and allowable methods of using said authorized scope of information data.
